(19) United States
(12) Patent Application Publication
(10) Pub. No.: US 2003/0172138 A1
(43) Pub. Date: Sep. 11, 2003

(54) System and method for managing two or more electronic devices

(76) Inventors: Jonathan I. McCormack, Charlotte, NC (US); Marco Boerries, Los Altos Hills, CA (US); Venkatachary Srinivasan, Sunnyvale, CA (US)

Correspondence Address: Pennie & Edmonds, LLP, 3300 Hillview Avenue, Palo Alto, CA, 94304, US

(21) Appl. No.: 10/384,224

(22) Filed: Mar. 7, 2003

Related U.S. Application Data
(60) Provisional application No. 60/363,802, filed on Mar. 11, 2002.
(60) Provisional application No. 60/363,810, filed on Mar. 11, 2002.
(60) Provisional application No. 60/363,877, filed on Mar. 11, 2002.
(60) Provisional application No. 60/363,876, filed on Mar. 11, 2002.

(51) Int. Cl. G06F 15/173

(52) U.S. Cl. 709/220; 709/223

(57) ABSTRACT

The present invention comprises a system and method for managing two or more electronic devices. This includes permanently maintaining at a central location a plurality of characterizations for each of the two or more electronic devices. Each characterization reflects the previous, current, or future state of a corresponding electronic device. Each characterization, moreover, is linked to each other characterization. As a result, a change to one characterization triggers a change to each other characterization. A characterization may change when a corresponding electronic device changes. Similarly, if a characterization is modified for other reasons (e.g., an electronic device corresponding to a linked characterization changes), the change is reflected in subsequent changes to a corresponding electronic device.

### RELATED APPLICATIONS

This application claims priority to, and incorporates herein by reference, an application entitled “SYSTEM AND METHOD FOR MANAGING TWO OR MORE ELECTRONIC DEVICES,” filed on Mar. 11, 2002, and identified by Ser. No. 60/363,802 and attorney docket number 11114-003-888.

This application is related to, and incorporates herein by reference, an application entitled “SYSTEM AND METHOD FOR ADAPTING PREFERENCES BASED ON DEVICE LOCATION AND NETWORK TOPOLOGY,” filed on Mar. 11, 2002, and identified by Ser. No. 60/363,810 and attorney docket number 11114-004-888; “SYSTEM AND METHOD FOR DELIVERING DATA IN A NETWORK,” filed on Mar. 11, 2002, and identified by Ser. No. 60/363,877 and attorney docket number 11114-005-888; and “SYSTEM FOR STANDARDIZING UPDATES OF DATA ON A PLURALITY OF ELECTRONIC DEVICES,” filed on Mar. 11, 2002, and identified by Ser. No. 60/363,876 and attorney docket number 11114-006-888.

### FIELD OF THE INVENTION

The present invention relates generally to managing two or more electronic devices. The present invention relates particularly to a system and method for ensuring that each of two or more electronic devices provide identical or, in the alternative, similar access to services.

### BACKGROUND

General State of the Art

The recent proliferation of electronic devices for recreation, information management and communication has taken routine computing power far away from the desk-bound personal computer. People in all walks of life are using such devices in the home, in the office, in factories, out in the field, and on the road. There are a diverse range of possible applications of such devices, including communication, business, navigation, entertainment, and even the management of basic household chores. The innovation rate continues to accelerate at a rapid pace—driven by end-user demand and the proliferation of new devices, standards, and protocols. Whereas today many users only access a single device for a single task, in the foreseeable future, users will want multiple functionality across many devices in their possession.

Although devices in use and those that can be envisaged come in all shapes and sizes, they present similar challenges for the people who make them and for the providers who offer services for them. This is because there are many attributes the devices share. Inside a typical device can be found hardware, and, interfacing with the user, the devices utilize various software components and often a complex operating system. Accordingly, there is potential for a single comprehensive infrastructure to be developed to enable a plethora of such devices to be upgraded, configured, and managed in a standardized manner. With standardization comes a greater desirability, reliability, and interoperability to meet the ever-increasing demands of end users.

Although cell phones, personal digital assistants, game stations, and car navigation systems are being used by a steadily increasing population of users, the level of user sophistication is not increasing significantly. Customers prefer to avail themselves of the advanced features of these devices without wanting the effort of configuring each new device for themselves. The user community is evolving into one that wants to take an idea, such as a list of frequently-dialed numbers, from one device to another but does not want to be distracted by the operating details of every device, nor the logistical complication of ensuring maximum consistency in their own data on all the available devices.

Furthermore, devices now becoming available are rarely single-function devices. Increasing the number of functions of a device only increases the level of personalization that is possible. Correspondingly, users are coming to expect unified access to their own data wherever they are—independent of what device they are using or what service they are connected to. Ideally, access to data should not depend on a user's location, as determined by which network a user has “roamed” into.

Accordingly, common problems associated with a world populated with a multitude of individual devices include: updating functionality on devices after sale, and preserving user-specific settings when coping with changes of location or device. These problems are preferably addressed by the companies that provide services and those that supply the devices rather than by the individual users. End users merely want devices that are easy to use, reliable, and enhanceable in a straightforward way.

Traditional service providers as well as large organizations such as airlines, banks, and a vast number of other enterprises, offer services to their customers and end users through devices. They want to increase their revenue from both existing and new services. They need to adopt ever more flexible ways of retaining existing customers and attracting new ones while continuing to add more services.

Device manufacturers want to upgrade existing devices with new software components more efficiently, and replace existing devices with new devices in such a way that time is not lost in transferring over a user's settings. The simpler it becomes for end users to upgrade and extend their usage, the more likely it is that those end users will buy new devices more frequently. Device manufacturers are also vying to sell additional devices to their installed customer base, for example a complex cell phone for business use and a simpler one for personal use. Along with service providers, device manufacturers want the flexibility to add new services, even to existing devices.

Thus, to successfully deploy, service, and maintain a plethora of devices, service providers and device manufacturers must be able to update them and add functionality to them after they have been sold. Such a capability not only preserves data, thereby enhancing its value to the user, but may also extend a device's useful lifetime. But such a task is complex not just because of the number of different types of devices currently available but because of the burgeoning number of individual users. Although a pair of devices may be identical, no two users are alike. So, vendors must get not just data to and from the device, but they must ensure user-specific or location-specific preferences are updated or maintained from one device to another, including when devices are replaced or upgraded. In short, vendors need flexible software component management, robust data management, and effective preference/configuration management.

Ultimately, then, end users want more device choices, more freedom to control preferences, more access to their data, and more personalization. At the same time, end users also want less hassle, less time spent reconfiguring preferences, and fewer worries about access to personal preferences while roaming and upgrading. Service providers want to be able to obtain more revenue from existing and new services, greater levels of customer retention, and more ways to improve the customer relationship. To achieve this, service providers want to minimize the overheads and time associated with deploying device upgrades, and want to spend less time on activities that are beyond their area of expertise. Device manufacturers want to be able to easily upgrade existing devices, sell more devices, and offer more services to gain a competitive advantage. Such gains will serve to optimize the product-development cycle time.

End User Expectations

Specific problems associated with personal devices such as cell phones are that end-users do not want to be troubled with the need to reset preferences every time they roam into a different network. Similarly, when upgrading an existing phone or purchasing a second phone, the user does not want to reset their preferences from scratch and reenter a phone book. Such personal trends run up against the technological trend that cell phones, for example, are getting more powerful with an increasing number of features that require either the end user or a service provider to configure.

With a large number of options such as SMS, MMS, wireless internet (WAP), fast internet access, “Bluetooth” connectivity, SyncML, transparent access to data such as e-mail, contacts, and calendar—even delivered through a corporate firewall, personalized ring tones and melodies, greater freedom to roam, and many others, cell phones are far from being fixed-function devices. Service providers and device manufacturers have to provide the appropriate device and preference functionality because users continue to demand more of their mobile devices.

Furthermore, the next generation of cell phones will be enhanced with PalmOS, Symbian, J2ME, WindowsCE, and other similar advanced operating systems to let service providers and end users download new software modules on their own. Similarly, personal digital assistants (PDA's) will have “Bluetooth”, infrared, wireless Ethernet (802.11a, 802.11b or 802.11g), or other connections to communicate with other electronic devices and to enable wireless access to the Internet and other networks from the PDA. Users will expect automatic configuration, so they simply achieve seamless access when they connect. Accordingly, software component management, data management, and preference/configuration management will become vital to make this efficient.

Correspondingly, the next generation of screen phones—whether based on traditional analog/digital circuit switched technology, or VoIP packet-switch technology—will offer an enhanced set of services that offer much more than a phone call. It is anticipated that end users will have access to voice and video conferencing while checking e-mail, contacts, calendar, stock quotes, news, and weather. Clearly, when presented with so many options, swift and easy upgrade of data and preferences will be desirable, if not essential.

Entertainment devices provide another arena in which standardization of upgrades and user preferences is likely to become important. Users of game consoles want to connect with a community of players so that they can compete, post scores, get hints and tips while playing, read game reviews, and generally share their experiences with other players around the world. Constant upgrades to game software and devices will be needed to satisfy these end users. But they will not be satisfied if they have to perform the upgrades themselves.

Similarly, televisions, set-top devices, personal video recorders, digital audio players such as MP3 players, and home audio systems have become devices with greatly enhanced functionality—including the ability to communicate with one another. The home entertainment center will soon comprise a number of separate but connected devices, enabling a variety of digital media to be shared throughout the house and among friends. The number of device upgrades required to achieve such a level of connectivity is likely to be more than any end user will be willing to make.

Many devices currently available can be referred to as “productivity devices.” For example, car navigation systems are already in widespread use. Car command centers can soon expect to be able to alert drivers to real-time traffic and construction delays. Plus, the ability to access e-mail, calendar, and address book from an in-car device will assist in improving productivity even when on the move. Even so, such facilities will benefit from transparent synchronized updates of individual users' preferences and data.

Internet terminals and “web pads” will, before long, offer very easy ways to perform standard functions such as internet browsing, e-mail transmission, calendar, as well as provide basic document creation tools such as word processors and spreadsheets. These systems and other systems with similar capabilities will serve as enhancements or extensions to PC's, without actually replacing PC's but will benefit enormously from synchronized update of preferences.

Daily life is also becoming more and more influenced by a category of devices known as “controller devices,” for example, cable routers, high-end appliances such as refrigerators, and alarm systems. Such devices typically take two forms: they are either the unseen black boxes that control certain critical daily functions; or they are the part of larger appliances that give the user functionality control. In both cases, these devices are converging towards other electronic devices in their capabilities, are becoming connected to the rest of the digital world and are communicating with other like devices. This convergence presents a challenge to service providers and device manufacturers not only because of the software management required, but also because these controllers have very long life cycles. With these long life cycles comes the need to enhance the controller devices while they are in use.

Today, these devices are hardware-intensive products that supply a single function. But as with personal devices, they are becoming more service-driven. Telemetry is one technology that allows the shift from product/device to product/service. Telemetry is a growing trend across a variety of devices that enables vendors to determine and analyze problems on working devices, fix the problems, and make adjustments to prevent the problems from recurring. As these devices get more user-specific and in need of constant upgrades, their complexity increases and the likelihood that they will benefit from a means for simplifying the upgrade process also increases. Telemetry is already being seen in cars, airplanes, and elevators today. Its application is likely to spread to phones, alarm systems, and “white goods” appliances.

In essence, people are wanting increasing levels of control, preferably from any where, on any device. Whether it is to control what their children can and cannot access on the internet and view on television or whether they want to control when their heater turns on and off, such levels of control require complex software component management, data management, and preference/configuration management.

Many household appliances, such as refrigerators, dishwashers, ovens, and washing machines, have not required network connections or software modules hitherto. In the future, the refrigerator, for instance, will be smart enough to monitor its own contents. But, in general, people simply want to buy a refrigerator that will be reliable and will last. Vendors, then, must somehow retain a customer relationship throughout a long product life cycle, so customers will want to purchase add-on services and retain brand loyalty. Using telemetry, service providers or device manufacturers can monitor devices such as a refrigerator, send data to their servers, analyze the data, modify the software, and prevent future problems. In a similar way, the car controller system monitoring the engine, fuel pump, etc., is not only interacting through the dashboard with the driver, but also can communicate with a service technician in real time.

This approach is far more cost-effective than sending a service technician out to the home each month to do the monitoring. In order for this monitoring to be carried out centrally and to be able to provide more comprehensive usage information, it would be useful to be able to update the state of the device easily. Such a capability would also benefit end users, who can have the same information at their disposal.

Communication controllers such as routers are specific devices for which end users and service providers both want more functionality, including features such as firewall, virtual private network, parental controls, anti-virus protection, and other services. The devices have got to run all the time, be secure, and enable access from any where, on any device. End users prefer the simplest interface possible, for example, selecting an internet service provider or paying a monthly fee, without worrying about its maintenance. That leaves the regular upgrading of the firewall, virtual private network, parental controls, and anti-virus protection to the service provider. The service provider would also like to monitor the device itself. For all of these tasks, the preference/configuration management and data delivery management demands are immense.

Phone system users in the home and in business want features such as conferencing, unified messaging, voice mail, routing, and forwarding without wanting to spend inordinate amounts of time setting preferences. They also want personalized features such as ring tones, melodies, and a specified number of rings before the phone switches to voice mail. And they expect their preferences to remain the same whether they upgrade or replace a device, or want to tie-in with their other devices. Organizations want to audit phone usage in order to negotiate better rates. Service providers and device manufacturers want to offer these services while monitoring reliability and usage. Basically, this is complex and difficult to manage with existing technologies.

The home or residential gateway is the single point where users connect all their communication systems, entertainment systems, alarm systems, heating and ventilation systems, and Instabus/X10 electrical systems. New standards for monitoring, controlling, and unifying these gateways are arising so users can turn on the house lights as they pull into the driveway, adjust the heat using their cell phone so it is ideal when they arrive, and check the status of all their systems while they are on vacation. The proliferation of new devices is nearly matched by the number of new protocols—resulting in a preference/configuration challenge for service providers and device manufacturers.

There has been a proliferation of wireless standards from 802.11a, 802.11b, and 802.11g to “Bluetooth” and HomeRF protocols. With multiple access points throughout the home or office, users add not only PC's but also PDA's, Web pads, and entertainment devices after the fact. Aside from the obvious compatibility problems, there is the matter of security: no one wants their neighbor or competitor using their wireless access points. Since end users do not want to manage and upgrade the device themselves, the responsibility falls to the service providers or device manufacturers to handle these complex demands.

Instabus or X10 systems must communicate with sensors and switches and aggregate a variety of devices. And a single alarm system must work with multiple monitoring devices—motion sensors, door and window sensors, glass-breaking sensors—and be accessed and operated from any where. The need for software component management, data management, and preference/configuration management is substantial.

In most large organizations, certain devices have to be up and running continuously. Planned downtime must be kept to a bare minimum. Unplanned downtime has severe negative consequences. This presents an enormous challenge to organizations because these devices are often in distant locations. Such devices must be centrally administered and managed—and the ability to update to new models while existing devices continue to be deployed is vital. These tend to be single-model devices, which means that any change affects a great number of devices. Thus, the organization's economic efficiency depends upon the way it manages these devices. Such devices are often referred to as “Vertical Solution” devices.

Organizations, service providers, and device manufacturers have been creating vertical solution devices such as banking terminals, cash registers, and industrial controllers for years. But the above challenges have forced them to commit precious time and resources to building homegrown solutions for device, preferences, and data management, which is not their core area of expertise.

From self-service terminals and dialog terminals to machine controllers, industry-specific devices are deployed by organizations and operated by customers or employees who may not be technically savvy. Ease of use and reliability are critical, because these devices are essential to the well-being of the organization. They play a key role in customer satisfaction, product and service delivery time, and overall productivity.

Banking terminals are examples of self-service terminals that originally provided customers the ability to deposit and withdraw money. As with all other computing devices, the functionality and features of these terminals continue to grow. Each branch wants to offer its own promotions and serve customers in a more personalized fashion. Location-based services—even non-banking services—greatly enhance the customer experience while directly benefitting the organization. Branches can target promotions depending on a customer's net worth. Or, they can base offers on whatever the interest rate happens to be on that given day. This requires continuous two-way communication with headquarters, so corporate data must be accessed and sent immediately. And if the terminal is not operating, it has a significant effect on customer satisfaction, which directly affects customer loyalty.

Check-in terminals are fast becoming a familiar sight in airports, rental car agencies, and at events such as movies and concerts. They need to be simple, because the end user does not want to read complicated instructions just to get tickets. They must also be reliable, because their purpose is to decrease the time spent in line and enhance customer satisfaction. The devices' feature sets must be able to change seamlessly and be easily customized so that airlines, for instance, can target promotions toward frequent fliers or alter promotions quickly as demands change.

Large chain stores and restaurants—and even some individually owned establishments—feature rather sophisticated cash registers, as well as other examples of “dialog terminals.” These devices are constantly altered to account for new products, prices, and customer-loyalty promotions. They also must accommodate ever-changing connectivity with bar-code and credit-card readers. And they must also be easily self-serviced by employees who have not been trained with the requisite computing skills.

Mobile data units are used by delivery companies such as Federal Express and United Parcel Service, transportation providers, rental car companies, and field-service personnel to improve customer satisfaction and productivity through two-way connectivity to headquarters. On the road, on the train, in the hospital, or at the construction site, these devices help keep people connected. This requires flexible connectivity—for example, Bluetooth on the road and Wi-Fi (e.g., 802.11b) at the home base. It is desirable for these devices to be seamlessly upgraded in real time, thereby extending the product life cycle.

Finally, industrial machines such as printing presses and assembly lines are reconfigured for the job at hand, whether that is a new print run or a new automobile model. As critical as these machines are to an organization's earnings, the operators tend to know their machines, not the computing backbone necessary to run them. This can be problematic since these machines can be among an organization's biggest investments—and if they stop working, the organization stops earning money. Ultimately it would be desirable to have access to a software infrastructure that allows the organizations or device manufacturers to build solutions that provide the ability to modify settings in real time and add new feature sets to improve productivity automatically.

### SUMMARY OF THE INVENTION

The present invention provides a solution to the above described problems. In particular, the present invention comprises a system and method for managing two or more electronic devices. This includes permanently maintaining at a central location a plurality of characterizations for each of the two or more electronic devices. Each characterization reflects the previous, current, or future state of a corresponding electronic device. Each characterization, moreover, is linked to each other characterization. As a result, a change to one characterization triggers a change to each other characterization. A characterization may change when a corresponding electronic device changes. Similarly, if a characterization is modified for other reasons (e.g., an electronic device corresponding to a linked characterization changes), the change is reflected in subsequent changes to a corresponding electronic device.

### BRIEF DESCRIPTION OF THE DRAWINGS

Additional objects and features of the invention will be more readily apparent from the following detailed description and appended claims when taken in conjunction with the drawings, in which:

FIG. 1 illustrates a system of electronic devices in accordance with an embodiment of the present invention.

FIG. 2 illustrates an electronic device that is consistent with an embodiment of the present invention.

FIG. 3 illustrates an intermediate server that is consistent with an embodiment of the present invention.

FIG. 4 illustrates exemplary processing steps for creating device DNA upon the creation of a corresponding account.

FIG. 5 illustrates exemplary processing steps for updating device DNA and making corresponding changes to electronic devices.

FIG. 6 illustrates exemplary processing steps for updating device DNA in response to changes to an electronic device, and making corresponding changes to other device DNA and electronic devices.

Like reference numerals refer to the same element throughout the several views of the drawings.

### DESCRIPTION OF THE PREFERRED EMBODIMENTS

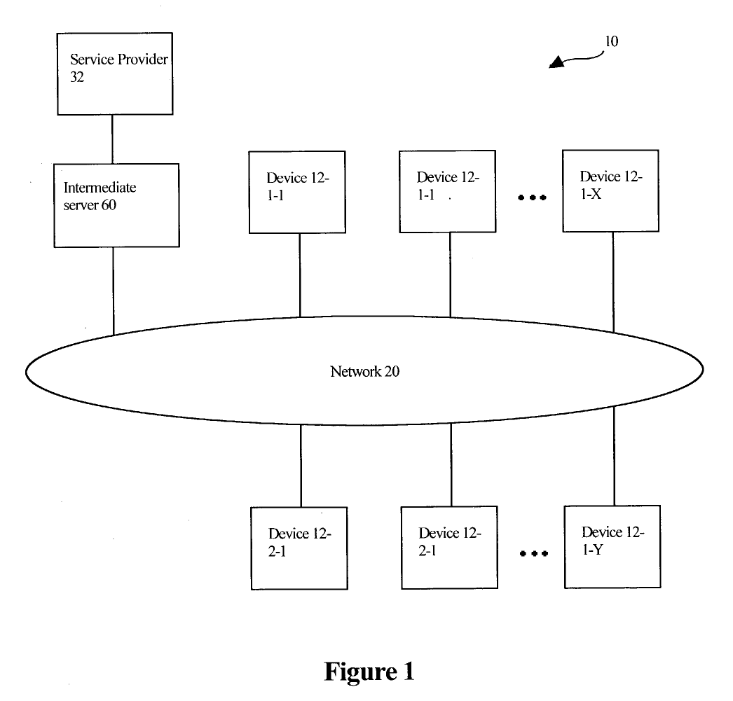

Referring to FIG. 1, there is shown a system 10 that is operated in accordance with one embodiment of the invention. System 10 includes a network 20, one or more electronic devices 12, an intermediate server 60, and a service provider 32. As illustrated in FIG. 1, each of the electronic devices 12 and the intermediate server 60 are connected to the network 20. The connection between the intermediate server 60 is typically a wireline connection (e.g., a connection comprising metallic wire conductors and/or optical fibers). The electronic devices 12 are not typified by any particular type of connection. The electronic devices 12 may be connected to the network 20 by a wireline connection and/or a wireless connection (e.g., a connection comprising electromagnetic waves such as RF, infrared, laser, visible light, and acoustic energy).

The precise technique used by the electronic devices 12 and the intermediate server 60 to establish a physical connection to the network 20, and thus each other 12, 60 is not critical to the present invention.

Service provider 32 is an electronic service such as an Internet service provider. Representative service providers 32 include, but are not limited to, Deutsche Telekom (Bonn Germany), Yahoo! (Sunnyvale, Calif.), AT&T Broadband (Denver, Colo.), Microsoft Network (Redmond, Wash.), Sprint (Kansas City, Mo.), FedEx Corporation (Memphis, Tenn.), and OnStar (http://www.onstar.com/flash.html). A service provider 32 can provide access to services such as stock tracking programs, address programs, and accounting programs, through the electronic devices 12—as described in more detail below. A service provider 32 can also provide access to services such as Microsoft Exchange Server (Redmond, Wash.), Internet Message Access Protocol (IMAP) server, and the Lightweight Directory Access Protocol (LDAP) Server. LDAP is designed to run directly over a TCP/IP stack. (See http://www.kingsmountain.com/ldapRoadmap.shtml#background). An IMAP server provides a method of accessing electronic mail or bulletin board messages that are kept on a mail server that may or may not be shared (see http://www.imap.org).

Although the network topology shown in FIG. 1 illustrates a service provider 32 that is external to the intermediate server 60, the invention is not limited to this network topology. In some embodiments of the present invention, server provider 32 is a software module that is hosted by the intermediate server 60.

In embodiments in which a service provider 32 is not hosted by the intermediate server 60, the service provider 32 and the intermediate server 60 are connected by a communications network. In some embodiments, the communications network is a local area network (LAN), wide area network (WAN), metropolitan area network (MAN), an Intranet, the Internet, or any combination of such networks.

As described in more detail below, a service provider 32 and an electronic device 12 communicate through the intermediate server 60. Generally, communication of data between computers, and other types of devices, within a first network (e.g., network 20) and between computers, and other types of devices, in another network (e.g., the communications network connecting a service provider 32 and the intermediate server 60) is handled by a hierarchy of protocols each of which simplifies a stage in the communication process (see, for example, Computer Networks, A Systems Approach, Peterson, L. L. and Davie, B. S., Morgan Kaufmann, Inc., 1996, incorporated herein by reference).

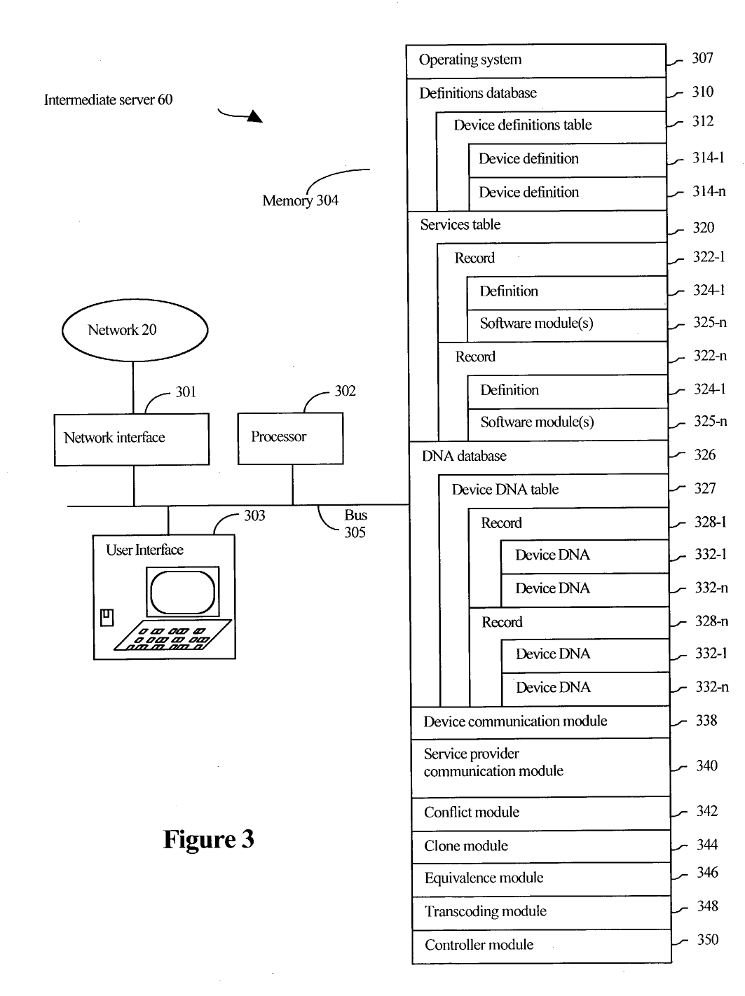

The service provider 32 typically creates an account for each user (e.g., corporate entity or individual) who uses the services provided by the service provider 32. The account typically specifies information such as usernames and passwords, authorized users, and service subscriptions (e.g., a given account may provide access to only a subset of the services provided by a given service provider 32). An account preferably specifies one or more electronic devices 12 that may be used in conjunction with the account. For example, a given account may indicate that a PDA and a cell phone (two types of electronic devices 12) may be used to access services provided by the service provider 32 (through the intermediate server 60). The account preferably includes, therefore, information that can be used to identify and/or contact an electronic device 12 (e.g., a telephone number of a cell phone) corresponding to the account. Additionally, the service provider 32 preferably provides a means for modifying the account. For example, a web based interface may be provided to enable a user to add, remove, or modify one or more services and electronic devices 12 corresponding to the account. Additionally, an electronic device 12 may be configured to access only a subset of services otherwise available to or through a corresponding account. As described in more detail below, this account information is passed on to the intermediate server 60, which incorporates this information into a device DNA table 327 (FIG. 3).

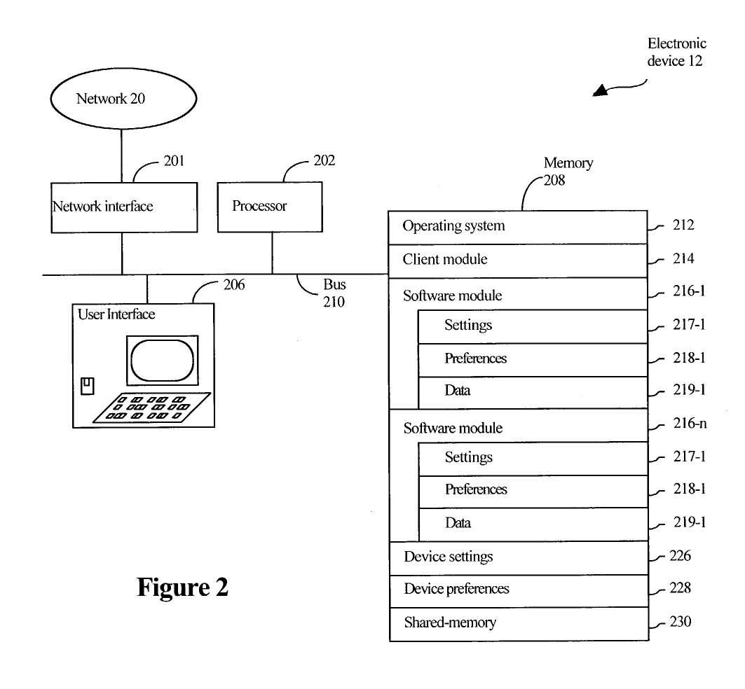

As illustrated in FIG. 2, an electronic device 12 typically includes the following components: a network interface 201, a processor 202, a user interface 206, a memory 208, and a bus 210, which interconnects the aforementioned components. The network interface 201 couples the electronic device 12 to the network 20. The precise structure of this component is governed by how the electronic device 12 communicates with the network 20 (e.g., wireless or wireline). The processor 202 executes various software modules maintained in the memory 208 as described in more detail below. The user interface 206 enables a user to interact with the electronic device 12 and typically includes components such as a keyboard, touch pad screen/display, microphone, and speakers.

The memory 208, which typically includes high speed random access memory as well as non-volatile storage such as disk storage, stores an operating system 212, a client module 214, one or more software modules 216, device settings 226, device preferences 228, and shared-memory 230.

The operating system 212 includes procedures for handling various basic system services and for performing hardware dependent tasks. The operating system 212 also provides software modules 214, 216 with access to system resources, such as the memory 208 and the user interface 206.

The client module 214 enables the intermediate server 60 to manage the electronic device 12. More specifically, the client module 214 can receive and process data from the intermediate server 60. For example, the intermediate server 60 may transmit over the network 20 a software module, and an instruction to install the software module, to the electronic device 12. The client module 214, in communication with the intermediate server 60, may then receive and initiate installation of the software module. The client module 214 also preferably has access to the shared-memory 230, device preferences 228, device settings 226, and software modules 216, including the settings 217, preferences 218, and data 219 of the software modules 216. Accordingly, the client module 214 is typically capable of modifying, adding, or deleting all or some aspect of each. The client module 214 may also transmit some or all of the device preferences 228, device settings 226, and software modules 216, including the settings 217, preferences 218, and data 219 of the software modules 216 to the intermediate server 60 and/or a service provider 32. The client module 214, moreover, may also transmit information about items including the device preferences 228, device settings 226, and software modules 216, including the settings 217, preferences 218, and data 219 of the software modules 216, without actually transmitting these items. For example, the client module 214 may only indicate that a change has been made to an aspect of a corresponding electronic device 12.

The client module 214 preferably communicates with the intermediate server 60 using an efficient protocol. In particular, the protocol preferably operates effectively over both wireless and wireline networks, is adaptable to the capabilities of each type of electronic device 12 described herein, and supports a wide variety of transport protocols. In some embodiments of the present invention, the client module 214 comprises a SyncML stack (see, for example, http://www.syncml.org).

The software modules 216 include all manner of software modules installed on electronic devices 12. An exemplary software module 12 is a e-mail program. E-mail programs in general include settings 217, preferences 218, and data 219. Settings 217 and preferences 218 are similar concepts and include, for example, limitations on the size of a corresponding address book and interface preferences. As indicated above, the data 219 may comprise an address book or other information.

The device settings 226 may control how the electronic device 12 interacts with the network 20. Each of the software modules 216, therefore, access the network 20 in a manner defined by the device settings 226. Similarly, the device preferences 228 may preselect certain options when such options are presented to the electronic device 12. For example, when a software module 216 is being installed, it may default to a particular language as defined by the device preferences 228.

The shared-memory 230 maybe used by the software modules 216, operating system 212, and/or the client module 214 to store information independently or under the direction of a user. For example, a service provided by a service provider 32 may include backing up some or all of the shared memory 230 (e.g., a subdirectory of a file system).

Persons skilled in the art recognize that the precise make up of the electronic device 12 depends upon its nature. For example, some electronic devices 12 are more complex than others. The more complex a electronic device is, the more likely it is that the electronic device 12 includes components not found in more simplistic electronic devices 12. Generally, all that is required by the present invention is a means for communicating with the intermediate server 60 (e.g., access to the network 20), elements manageable by the intermediate server 60 (e.g., device settings 226), and a means for managing the manageable elements (e.g., client module 214). The range of electronic devices 12 includes but is not limited to handheld computers, laptops, switches, routers, appliances, wearable computers, personal digital assistants, cellular telephones, pagers, electronic note-pads, palm-top computers, e-books, smart-cards, cameras, dicta phones, heart-rate monitors, cycle computers, pedometers, wristwatch computers, GPS devices, electronic toys, games, or other amusement devices, and home security controllers.

Persons skilled in the art recognize that a switch, which is a type of electronic device as noted above, is a layer 2 network device that selects a path or circuit for sending a unit of data to its next destination, where layer 2 refers to a the second layer in the International Organization for Standardization Reference Model of Open System Interconnection (ISO OSI Model). It will be appreciated, however, that a switch may also include the function of a router, which is a layer 3 device or program that can determine the route and specifically what adjacent network point the data should be sent. A router is also a type of electronic device as noted above. For more information on switches and routers, see Peterson and Davie, Computer Networks, 1996, Morgan Kaufmann Publishers, Inc, San Francisco Calif.

As illustrated in FIG. 3, the intermediate server 60 includes standard server components including a network interface 301 for coupling intermediate server 60 to other devices via network 20, a processor 302 for executing various software modules maintained in a memory 304, an optional user interface 303 (e.g., keyboard, mouse, and display), the memory 304, and a bus 305 for interconnecting the aforementioned components.

The memory 304, which typically includes high speed random access memory as well as non-volatile storage such as disk storage, stores a number of software modules and data structures that are used in accordance with the present invention. In a typical embodiment, the memory 304 includes an operating system 307, which generally comprises procedures for handling various basic system services and for performing hardware dependent tasks, a definitions database 310, a services table 320, a DNA database 326, a device communication module 338, a service provider communication module 340, a conflict module 342, a clone module 344, an equivalence module 346, a transcoding module 348, and a controller module 350.

The definitions database 310 preferably includes at least a device definitions table 312, which describes electronic devices 12 in detail. More specifically, the device definitions table 312 comprises a record 314 for each of the types of electronic devices 12 with which the intermediate server 60 may communicate. The records 314 preferably include fixed hardware descriptions, removable hardware descriptions, and operating system (and/or other required software module) descriptions for these electronic devices 12. The records 314 also preferably include information such as typical device configurations, supported software modules, feature sets, and hardware limitations. For example, if a particular type of an electronic device 12 (e.g., a hand held computer) only has black and white displays, this fact is included in a corresponding device definition 314. As described in more detail below, each record 314 includes information that enables the creation of device DNA for a corresponding electronic device 12. The device definitions table 312 is preferably updated as new electronic devices 12 become available.

The services table 320 comprises a plurality of records 322 for each service offered by a service provider 32. Each of the plurality of records 322 preferably include a sub-record 324 with a definition of (e.g., information about) a corresponding service and a sub-record 325 with one or more software modules used in conjunction with the corresponding service. The definition sub-record 324 preferably includes, but is not limited to, a description of the service, a list of services or software modules with which the service conflicts, authentication requirements for using the service, device hardware requirements of the service, and software module requirements of the service. Memory usage and processor speed requirements, for example, may be included in the definition. The software module(s) sub-record 325 includes each software module that may be required by a corresponding service. In other words, the software module(s) sub-record 325 includes software modules such as e-mail programs, games, dynamic link libraries, and virtual machines and software modules such as patches and/or upgrades that modify other software modules. The services table 320 is preferably created and/or updated as information (e.g., definitions and software modules) becomes available.

The DNA database 326 includes one or more tables storing DNA. In particular, the DNA database 326 includes a device DNA table 327, which stores device DNA for each electronic device 12 that may interact with the intermediate server 60. More specifically, the device DNA table 327 includes a record 328 for each account created by the service provider 32 and forwarded to the intermediate server 60 as described above. Each of these records 328 includes a sub-record 332 for each electronic device 12 corresponding to the account. Included in a sub-record 332 is device DNA for a corresponding electronic device 12. For example, device DNA for a given electronic device 12 typically includes: a fixed hardware description, a removable hardware description (including whether a given removable hardware component was ever attached), a list of software modules installed on the electronic device 12, software module settings and preferences, a description of the data for each of the software modules (but preferably not the data itself), data source settings, a list of users who can use the electronic device 12, the device specific configuration for each service available through the electronic device 12 (e.g., the location of an e-mail server), and device specific mappings of data sources (e.g., which address book entries are stored on which device for a specific user). Descriptions of the data typically identify when the data was last changed, periods in which the data did not change, how many entries are included in the data (in the case of a list or database), the size of the data, and/or a general description of the data. The sub-record, moreover, may include any corresponding information found in the definitions database 310 and the services table 320. There is a one to one correspondence between each electronic device 12 in the system 10 and corresponding device DNA maintained in a record 332.

As described in detail below, device DNA may be uploaded to the intermediate server 60 from electronic devices 12 in order to update a corresponding device DNA entry 332. Additionally, an update of the device DNA may be triggered by the service provider 32 when, for example, a user adds or removes a service accessible through one or more electronic devices 12 corresponding to the user's account. The device DNA of a given account may also be modified in a manner that corresponds to changes made to another device DNA corresponding to a common account.

As noted above, the data itself is preferably not included in the device DNA. Instead, the data is maintained and/or backed-up, if at all, by the service provider 32. So when the intermediate server 60 copies data from one electronic device 12 to another (as described in detail below), the data is typically obtained from a service provider 32. Nevertheless, device DNA may include settings and/or preferences from a corresponding electronic device 12. As a result, an electronic device 12 may obtain settings and/or preferences directly from device DNA of another electronic device 12 instead of, or in addition to, the intermediate server 60.

Again, the service provider 32 typically provides a defined number of services. Additionally, an electronic device 12 may include software modules and data unrelated to the services provided by a service provider 32. In preferred embodiments of the present invention, information pertaining to such software modules and data is not included in the device DNA. Instead, such information is preferably excluded entirely from the device DNA or included only to the extent that it affects software modules, data, etc., corresponding to a service provided by a service provider 32. For example, if the services table 320 indicates that a first software module (e.g., a software module not included in the services table 320) conflicts with a second software module (e.g., a software module included in the services table 320), the device DNA may reflect that the first software module is installed on a corresponding electronic device 12 to avoid conflicts.

The service provider communication module 340 communicates with a service provider 32. The protocol that the service provider communication module 340 uses to communicate with a service provider 32 depends upon the exact specifications of the service provider 32. Typically, however, the service provider communication module 340 employs one or more open web standards known in the art to communicate with a service provider 32.

The device communication module 338 communicates with electronic devices 12. Device communication module 338 works in conjunction with the controller module 350 (described below) and the device DNA table 327 in order to accomplish this task. More specifically, the device communication module 338 uses the information in the device DNA table 327 to customize communication with a respective electronic device 12. For example, the device communication module 338 uses the information in the device DNA table 327 to select a protocol that is most efficient given the characteristics of the respective electronic device 12.

The conflict module 342 is designed to avoid conflicts concerning software modules that are, or may be, installed on an electronic device 12. As indicated above, the services table 320 defines software modules needed to provide a particular service and defines dependencies and conflicts between services, between services and software modules, and between services and hardware components (e.g., the size of memory 208). Using this information, in conjunction with device DNA, the conflict module 342 determines whether a software module to be installed on an electronic device 12 will operate successfully. If not, the conflict module 342 modifies the device DNA such that this software module is not installed until the conflict module 342 determines that the software module will operate successfully. A change in such a determination usually results from software and/or hardware changes on the corresponding electronic device 12 (e.g., a conflicting software module is removed and/or memory 208 is expanded).

The clone module 344 is designed to make services (e.g., data, preferences, settings, software modules) available on an old electronic device 12 available on a new electronic device 12. More specifically, the clone module 344 migrates the device DNA of the old electronic device 12 into a new device DNA entry 332 (typically corresponding to the same account record 328). As described in more detail below, the next time the new electronic device 12 connects to the intermediate server 60, any software modules, settings, preferences, and/or data defined by the new device DNA entry 332 are downloaded to the new electronic device 12 (in what may be termed a bootstrap process). Note that the device DNA is not typically an exact copy since information such as device identification usually must be unique; but the services provided by corresponding electronic devices 12 usually are identical. The clone module 344 is typically employed when a user upgrades to a new electronic device 12, when a user acquires a second electronic device 12, and when an existing electronic device 12 is lost and replaced.

The equivalence module 346 is designed to identify a means for providing equivalent access to services that are not otherwise available. Typically, a service provider 32 provides services that can only be accessed by specific software modules installed on an electronic device 12. More specifically, a first software module may be used by a first electronic device 12 to provide access to a service; whereas a second software module may be used by a second electronic device 12 to provide access to the same service. This is usually the result of differences between the first electronic device 12 and the second electronic device 12 (e.g., hardware differences and/or software differences). For example, e-mail service on a cell phone and a PDA (two types of electronic devices 12) may be provided by different software modules and include different feature sets, but access the same e-mail account. In other words, the access to the e-mail account is not equivalent on the respective electronic devices 12. Another example is a word processing software module operating on a relatively robust electronic device 12. Less robust electronic devices 12 (e.g., electronic devices 12 with less memory 208) may not be able to run the same word processing software module. Instead, the less robust electronic device 12 may operate a less demanding word processing software module—with a correspondingly limited set of features. In other words, the two electronic devices 12 do not provide the same access to an idealized word processing software module.

The equivalence module 346 is typically engaged when a first electronic device 12 is modified to provide access to a service provided by the service provider 32. The equivalence module 346 identifies software modules needed to provide equivalent access to the service on one or more other corresponding electronic devices 12 (e.g., electronic devices 12 corresponding to a common account). The equivalence module 346 then uses these identifications to modify the device DNA corresponding to the one or more other corresponding electronic devices 12. As described in more detail below, the next time the one or more other corresponding electronic devices 12 connect to the intermediate server 60, any software modules, settings, preferences, and/or data defined by the modified device DNA entry are downloaded to the one or more other corresponding electronic devices 12. The one or more other corresponding electronic devices 12 may then be capable of providing the same or equivalent access to the service.

The transcoding module 348 is designed to provide a plurality of views of data to match the capabilities of different electronic devices 12. For example, on an electronic device 12 with limited memory 208, only contacts of a contact list that have been accessed within a predefined period of time are transmitted to and stored by the electronic device 12. In this situation, the transcoding module 348 filters contact information sent to this electronic device 12. More specifically, control information is stored in the device DNA of an electronic device 12. The control information defines the view of information required by a corresponding electronic device 12. Each time this electronic device 12 accesses a particular service, the control information (e.g., the device DNA) is used by the transcoding module 348 to identify data items from a data source stored by a corresponding electronic device and the format of the data items. For example, a particular data item may comprise three fields one a first electronic device 12, but one field on a second electronic device 12. The transcoding module 348 detects this fact and takes appropriate steps to transform the data as it is transmitted back and forth between the electronic devices 12 and between electronic devices 12.

To clarify, take the example of two electronic devices 12 operating different word processing software modules cited above with respect to the equivalence module 346. Because one word processing software module may not be able to process, for example, certain style sheets supported by the other word processing software module, the transcoding module 348 may allow transmission of a document created on the robust electronic device 12 only after the document has been saved to a version supported by the word processing software module running on the less robust electronic device 12. In other words, the transcoding module controls the view of the document by reference to device DNA.

The controller module 350 typically orchestrates the activities of the various modules described above. The controller module 350 also executes tasks not allocated to any of the various modules described above.

A general description of the electronic devices 12, a service provider 32, and the intermediate server 60 has been provided. Attention now turns to a more detailed description of processing steps taken in a preferred embodiment of the present invention.

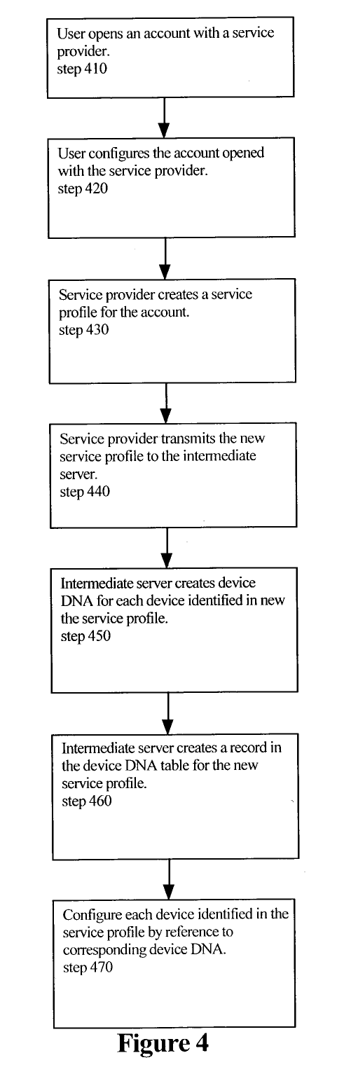

Referring to FIG. 4, there is shown a series of steps leading up to the creation of device DNA. In a first step, a user opens an account with a service provider 32 (step 410). The precise means for opening an account may vary with each service provider 32. Typically, service providers provide web-based interfaces that permit a user to open an account or service telephone calls or other off-line means of communication that permit a user to open an account.

The user then configures the account opened with the service provider 32 (step 420). Typically, this includes selecting one or more username and password combinations. The number of username and password combinations may be affected by the number of users who may access services provided by the service provider 32 through the account. The number of username and password combinations may also be affected by the levels of service a user desires. For example, a first username and password combination may provide services required for business use; a second username and password combination may provide services required for personal use. The user also specifies the number and identity of electronic devices 12 that may be used in conjunction with the account. Some electronic devices 12 require still more information such as a telephone number in the case of an electronic device 12 such as a cell phone. The user, furthermore, selects services provided by the service provider 32 that may be accessed in conjunction with the account generally and a subset of these services that may be accessed through each identified electronic device 12. Note that the subset may actually include all of the services that may be accessed in conjunction with the account.

From the information provided by the user, and possibly other information, the service provider 32 creates a service profile for the account (step 430). The service profile describes in detail the services, electronic devices, and users associated with the account. The “other” information may include, for example, service limitations imposed on the user's account that were not selected by the user. The “other” information may also include implementation information for one or more of the services that may be accessed in conjunction with the account. This “other” information is typically supplied and/or defined by the service provider 32.

The service provider 32 then transmits the new service profile to the intermediate server 60 (step 440). In a preferred embodiment, the service provider 32 interacts with the service provider communication module 340 on the intermediate server 60 to transmit the service profile to the controller module 350 on the intermediate server 60.

The intermediate server 60 responds by creating device DNA for each electronic device 12 identified in the new service profile (step 460). Typically, the controller module 350 initiates the process of creating device DNA by identifying—for each of the electronic devices 12 identified in the service profile—software modules needed to access one or more defined services through a respective electronic device 12. The identification is executed by cross-referencing the service profile with the services table 320. For example, if a particular service is identified, the controller module 350 accesses the services table 320 to identify software modules 325 that may provide the particular service. The controller module 350 also accesses the device definitions table 312 to obtain information concerning electronic devices 12 identified in the service profile. The information obtained in step 460 thus far forms the nucleus of device DNA.

The controller module 350 then directs the conflict module 342 to process the device DNA to identify conflicts between software modules selected for respective electronic devices 12 and between respective electronic devices 12 and software modules. For example, the conflict module 342 confirms that each identified electronic device 12 is capable of providing the services selected for the respective electronic devices 12 (e.g., operate corresponding software modules). The conflict module 342 also determines any operating limitations. For example, a first software module cannot operate at the same time as a second software module on a given electronic device 12. The conflict module 342 then modifies the device DNA accordingly (e.g., to indicate any conflicts or operating limitations and the source(s) thereof). This last step may facilitate subsequent modifications to (e.g., upgrades of) an electronic device 12 when one or more sources of any conflicts or operating limitations are eliminated.

If any conflicts prevent an electronic device 12 from providing a service, the controller module 350 directs the equivalence module 346 to identify a software module that enables an electronic device 12 to provide equivalent access to the service. If such an identification is possible (e.g., there are such software modules available), the device DNA is modified so that the electronic device 12 provides the equivalent access to the service.

The intermediate server 60 then creates an account record 328 in the device DNA table 327 for the new service profile (step 450). More specifically, the controller module 350 creates a record 328 with one or more sub-records 332 for each electronic device 12 identified in the service profile. The device DNA is copied into corresponding sub-records 332. In some embodiments, the account record 328 may also include an additional sub-record containing information (e.g., device DNA) that pertains to all of the device DNA sub-records 332. This minimizes the size of the device DNA table 327 since duplicate information is minimized.

The controller module 350, in conjunction with the device communication module 338, then configures each electronic device 12 identified in the new service profile by reference to corresponding device DNA (step 470). More specifically, the controller module 350 detects the first time each of the electronic devices 12 identified in the service profile access the service provider 32 through the intermediate server 60. When this occurs, the controller module 350 downloads the client module 214 to the electronic device 12 if it is not already installed on the electronic device 12. In one embodiment, the controller module 350 transmits an installer module, which when executed on an electronic device 12 by a user installs the client module 214. The controller module 350 interacts with the electronic device 12 through the client module 214 to identify the current state of the electronic device 12. If the current state of the electronic device 12 is inconsistent with the device DNA stored in a corresponding sub-record 332, the controller module 350 initiates a download of one or more software modules, preferences, and or settings as defined by the device DNA. The electronic device 12 may then be capable of providing access to the services as defined by the corresponding device DNA.

The synchronization process (e.g., modifying an electronic device 12 to match corresponding device DNA) is typically initiated by the client module 214 in response to a user command. For example, some cell phones and PDA, two types of electronic devices, often provide access to a synchronize command. But in some embodiments, the controller module 350 initiates a synchronization between the device DNA and an electronic device 12. These embodiments usually involve electronic devices 12 that are always networked or otherwise accessible by the intermediate server 60. An example of such an electronic device may be a router, which may be connected to, for example, a corporate network with a persistent connection to the network 20. In this situation, bandwidth probably is not a concern so there is no need to wait for user initiation. In the case of a cell phone or other electronic device 12 with only intermittent connection to the intermediate server 60, the user may not wish to be delayed by a synchronization.

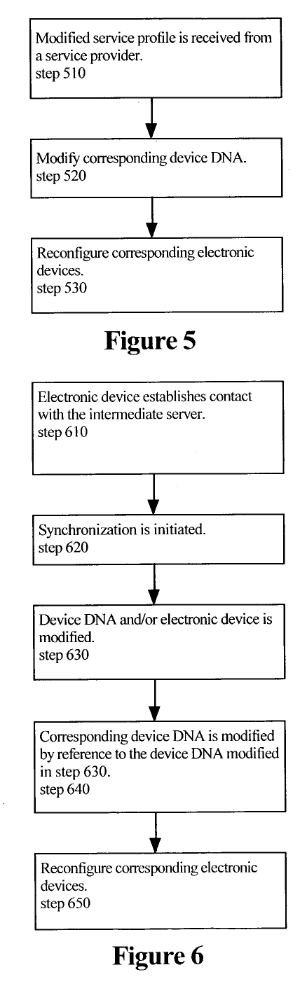

Referring to FIG. 5, there is shown a series of steps leading up to the reconfiguration of one or more electronic devices in response to changes to a corresponding service profile. In a first step, a modified service profile is received from a service provider 32 (step 510). Typically, the service profile is received by the service provider communication module 340, which forwards the service profile to the controller module 350. Additionally, a modified service profile is typically created when either a service provider 32 or a user (through the service provider 32) makes changes to a corresponding account. For example, a user may decide to discontinue one or more services, add one or more services, or change which electronic devices 12 can be used to access one or more services.

The controller module 350 then directs modifications to a corresponding record 328 in the device DNA table 327 as needed (step 520). The controller module 350 initiates the process of modifying device DNA by identifying—for each of the electronic devices 12 identified in the service profile—software modules now needed or no longer needed to access one or more defined services through a respective electronic device 12. The identification is executed by cross-referencing the modified service profile with the services table 320. For example, if a new service is identified, the controller module 350 accesses the services table 320 to identify software modules 325 that may provide access to the new service. The controller module 350 also accesses the device definitions table 312 to obtain information concerning electronic devices 12 identified in the modified service profile. The controller module 350 then uses this information to update device DNA corresponding to the modified service profile. Note that some device DNA corresponding to the modified service profile may not be modified. For example, if the modified service profile eliminates restrictions imposed on some but not all of the electronic devices 12 corresponding to the service profile, the controller module 350 will typically modify the device DNA corresponding to these electronic devices 12 only. In other words, the device DNA that does not correspond to these electronic devices 12 may not, therefore, be updated since the restrictions mentioned above were not imposed on these electronic devices 12.

Additionally, if the modified service profile indicates that a particular electronic device 12 should no longer provide access to a particular service, aspects of corresponding device DNA pertaining to this service are removed, and the device DNA is modified to indicate that the ability of the electronic device 12 to provide access the service should be eliminated (e.g., a corresponding software module should be deleted). Furthermore, if a particular electronic device 12 has been removed from an account, the controller module 350 preferably modifies corresponding device DNA such that upon the next connection to the intermediate server 60 by the electronic device 12, the ability of the electronic device 12 to provide access services provided by the service provider 32 should be eliminated and the corresponding device DNA deleted or otherwise deactivated.

The controller module 350 then directs the conflict module 342 to process updated device DNA to identify conflicts between software modules selected for respective electronic devices 12 and between respective electronic devices 12 and software modules. For example, the conflict module 342 confirms that each identified electronic device 12 is capable of providing the services selected for the respective electronic devices 12 (e.g., operate corresponding software modules). The conflict module 342 also determines any operating limitations. For example, a first software module cannot operate at the same time as a second software module on a given electronic device 12. The conflict module 342 then modifies the device DNA accordingly (e.g., to indicate any conflicts or operating limitations and the source(s) thereof). This last step may facilitate subsequent modifications to (e.g., upgrades of) an electronic device 12 when one or more sources of any conflicts or operating limitations are eliminated.

If any conflicts prevent an electronic device 12 from providing a service, the controller module 350 directs the equivalence module 346 to identify a software module that enables an electronic device 12 to provide equivalent access to the service. If such an identification is possible (e.g., there are such software modules available), the device DNA is modified so that the electronic device 12 provides equivalent access to the service.

Additionally, if the modified service profile calls for the cloning of an electronic device 12, all of the sub-steps described above in connection with step 520 may not be required. Instead, the controller module 350 directs the clone module 344 to clone one or more identified electronic devices 12. As noted above, cloning includes copying existing device DNA into a new record 332 and associating the copied device DNA with another electronic device 12. The conflict module 342 and the equivalence module 346 are typically not required since conflicts and equivalent services have already been identified for the cloned electronic device 12.

The controller module 350, in conjunction with the device communication module 338, then reconfigures corresponding electronic devices 12 (step 530). More specifically, the controller module 350 detects the next time each of the electronic devices 12 corresponding to modified or new device DNA access the service provider 32 through the intermediate server 60. When this occurs, the controller module 350 downloads the client module 214 to the electronic device 12 if it is not already installed on the electronic device 12 (which may occur if the modified service profile adds an electronic device 12 to an account). The controller module 350 interacts with the electronic device 12 through the client module 214 to identify the current state of the electronic device 12. If the current state of the electronic device 12 is inconsistent with the device DNA stored in a corresponding sub-record 332, the controller module 350 initiates a download of one or more software modules, preferences, and or settings as defined by the device DNA. The electronic device 12 may then be capable of providing access to the services as defined by the corresponding device DNA (e.g., the modified service profile).

As noted above, a user must initiate a synchronization between an electronic device and corresponding device DNA in some embodiments. In such embodiments, the controller module 350 may transmit—through the device communication module 338—a request for the user to initiate the synchronization process. For example, the device communication module 338 may utilize SMS in the case of GSM digital cellular telephone, which is a type of electronic device 12, to send the request. Persons skilled in the art recognize that SMS, which stands for Short Message Service, is a message service offered by the GSM digital cellular telephone system. SMS messages are typically buffered by a GSM network until the corresponding, digital cellular telephone becomes active.

Referring to FIG. 6, there is shown a series of steps leading up to the reconfiguration of one or more electronic devices 12 in response to changes made to a corresponding electronic device. As noted above, changes to an electronic device 12 may be initiated by what may be considered the back-end. In other words, the changes are not initiated by or from an electronic device 12. Instead, the changes come from the service provider 32 (though a user may ultimately be the initiator). However, it is possible that an electronic device 12 is changed independently of the service provider 32 in a manner that requires related changes to one or more corresponding electronic devices 12. A user may, for example, modify preferences or settings on an electronic device 12 such that the controller module 350 responds by replicating the changes—to the greatest extent possible—on other, corresponding electronic devices 12. For example, a user may change the signature automatically added to e-mail messages by an e-mail program operating on an electronic device 12. Another example is that of a user adding an entry to a local copy of an address book used in conjunction with an e-mail program operating on an electronic device 12. In this specific example, the new data (e.g., the new entry) may also be backed-up by the service provider 32 (e.g., a copy of the address book is maintained separately by the service provider 32).

Similarly, a given account may be configured to replicate the creation of new services, made possible by changes to an electronic device 12, to all other corresponding electronic devices 12. For example, if a service provider 32 offers e-mail service, to which the user subscribes, the controller module 350 may automatically add the ability to provide access to this service to corresponding electronic devices 12 if the user independently adds enabling software to an electronic device 12.

In a first step, an electronic device 12 establishes contact with the intermediate server 60 (step 610). For example, a user may log into the service provider 32 using an electronic device 12 with corresponding device DNA in the device DNA table 327. As noted above, when a user contacts the service provider 32 in this manner, contact is made through the intermediate server 60 such that contact is established with the intermediate server 60.

In a second step, synchronization between the electronic device 12 and corresponding device DNA is initiated (step 620). As noted above, synchronization can be initiated by the controller module 350 or the electronic device 12—typically under the direction of a user.

The device DNA and/or the electronic device 12 are then modified as needed (step 630). Synchronization may involve device DNA changes being reflected on a corresponding electronic device 12 or electronic device 12 changes being reflected in corresponding device DNA. If, for example, a device setting 226 has been changed on the electronic device 12, the device DNA is modified to reflect this change. Similarly, if the synchronization process indicates that the device DNA corresponding to the electronic device 12 has changed, the controller module 350 initiates the process of updating the electronic device 12. For example, the updating may include downloading a software module for installation on the electronic device 12.

If the device DNA of an electronic device 12 is modified in step 630 due to changes on the electronic device 12, the controller module 350 directs corresponding changes to device DNA connected to the same account as the device DNA modified in step 630 (e.g., corresponding device DNA) (step 640). The controller module 350 initiates the process of modifying device DNA by identifying software modules now needed or no longer needed to access one or more defined services through a respective electronic device 12 by reference to distinctions between the modified device DNA and corresponding device DNA. Again, it may be, for example, that a given electronic device 12 is already capable of providing access to a service newly available through the modified electronic device 12. As a result, a change with respect to this service may not be required.

The identification is executed by cross-referencing the distinctions between the modified device DNA and corresponding device DNA with the services table 320. For example, if the distinction represents a service newly available through the modified electronic device 12, the controller module 350 may access the services table 320 to identify software modules 325 that may provide the new service on one or more other electronic devices 12. Of course, it is possible that the same software that enables the service through the modified electronic device 12 is required for the one or more other electronic devices 12. The controller module 350 also accesses the device definitions table 312 to obtain information concerning electronic devices 12 that require modification to, for example, provide the service newly available through the modified electronic device 12. The controller module 350 then uses this information to update device DNA corresponding to one or more electronic devices 12. In preferred embodiments, it is only those electronic devices 12 already consistent with the modified electronic device 12 are not modified.

The controller module 350 then directs the conflict module 342 to process updated device DNA to identify conflicts between software modules selected for respective electronic devices 12 and between respective electronic devices 12 and software modules. For example, the conflict module 342 confirms that each identified electronic device 12 (e.g., each electronic device 12 that must be modified to, for example, provide a service newly available through the modified electronic device 12) is capable of providing the service (e.g., operate corresponding software modules). The conflict module 342 also determines any operating limitations. For example, a first software module cannot operate at the same time as a second software module on a given electronic device 12. The conflict module 342 then modifies the device DNA accordingly (e.g., to indicate any conflicts or operating limitations and the source(s) thereof). This last step may facilitate subsequent modifications to (e.g., upgrades of) an electronic device 12 when one or more sources of any conflicts or operating limitations are eliminated.

If any conflicts prevent an electronic device 12 from providing a service, the controller module 350 directs the equivalence module 346 to identify a software module that enables an electronic device 12 to provide equivalent access to the service. If such an identification is possible (e.g., there are such software modules available), the device DNA is modified so that the electronic device 12 provides equivalent access to the service.

As noted above, the change to an electronic device 12 may comprise, for example, a modified device setting 226 or preference 228. In such cases, new software may not be required for corresponding electronic devices 12. However, the controller module 350 preferably directs the conflict module 342 to determine if changes to the same or similar settings or preference on one or more corresponding electronic devices 12 creates a conflict. If the conflict module 342 determines that certain changes will cause conflicts, the controller module 350 directs the equivalence module 346 to identify equivalent changes. For example, if any are identified, the conflict module 342 is again directed to identify potential conflicts. This process is repeated until equivalent changes are identified or until it is determined that no change can be made.

Similarly, if a device setting, for example, modified on a given electronic device 12 is not included on a corresponding electronic device 12, the controller module 350 preferably directs the equivalence module 346 to identify an equivalent device setting. For example, a device setting may include settings for 802.11, which is an IEEE Wireless LAN protocol. The 802.11 protocol may not be on all electronic devices 12, but a possible equivalent to this particular device setting may include settings for Bluetooth, which is another wireless network protocol. The equivalence module 346 proceeds by scanning the device DNA of the corresponding electronic device 12 for an equivalent device setting. If such a setting is found, the equivalence module 346 modifies the device DNA accordingly. If not, the equivalence module 346 modifies the device DNA such that if an equivalent device setting becomes available, the device DNA is again modified. This time, the new device setting will be propagated to the corresponding electronic device 12.

The controller module 350, in conjunction with the device communication module 338, then reconfigures corresponding electronic devices 12 (step 650). More specifically, the controller module 350 detects the next time each of the electronic devices 12 corresponding to modified device DNA access the service provider 32 through the intermediate server 60. The controller module 350 interacts with the electronic device 12 through the client module 214 to identify the current state of the electronic device 12. If the current state of the electronic device 12 is inconsistent with the device DNA stored in a corresponding sub-record 332 (e.g., the device DNA has been modified to include outstanding data, requests for data, or user prompts that need to be communicated to the electronic device), the controller module 350 initiates a download of one or more software modules, preferences, and or settings as defined by the device DNA. The electronic device 12 may then be capable of providing access to the services as defined by the corresponding device DNA. Note that it is possible that a user independently made changes to two or more electronic devices 12. As a result, a given electronic device 12 may already be consistent with the device DNA.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method of managing two or more electronic devices, comprising
permanently maintaining at a central location a plurality of characterizations, wherein said plurality of characterizations includes a separate characterization for each of the two or more electronic devices;
linking the plurality of characterizations, wherein a change to a characterization included in said plurality of characterizations triggers a separate change to each other characterization included in said plurality of characterizations; and
synchronizing the separate characterization to a respective electronic device from the two or more electronic devices, wherein a change to said separate characterization triggers a corresponding change to said respective electronic device and wherein a change to said respective electronic device triggers a corresponding change to said separate characterization.

2. The method of claim 1, wherein the separate characterization includes a characterization of data on a corresponding electronic device, said characterization not including said data.

3. The method of claim 1, wherein the separate characterization includes a characterization of a software module on a corresponding electronic device, said characterization not including said software module.

4. The method of claim 1, wherein the separate characterization includes a characterization of a hardware component included in a corresponding electronic device.

5. The method of claim 1, wherein the separate characterization includes a characterization of electronic device settings of a corresponding electronic device.

6. The method of claim 1, wherein the separate characterization includes a characterization of user defined preferences of a corresponding electronic device.

7. The method of claim 1, wherein the separate characterization comprises control information for data maintained on a corresponding electronic device.

8. The method of claim 1, wherein the separate characterization includes a description of data maintained on a corresponding electronic device.

9. The method of claim 1, wherein the separate characterization includes configuration information for a service provided by a corresponding electronic device.

10. The method of claim 1, wherein the separate characterization includes configuration information for a service to which access is provided by a corresponding electronic device.

11. The method of claim 1, wherein the electronic device comprises pager.

12. The method of claim 1, wherein the electronic device comprises handheld computing device.

13. The method of claim 1, wherein the electronic device comprises a telephone.

14. The method of claim 1, further comprising
generating a characterization with reference to one or more characterizations included in the plurality of characterizations.

15. The method of claim 14, further comprising
receiving information from an electronic device corresponding to the characterization, wherein said information is integrated into said characterization.

16. The method of claim 14, further comprising
prompting the electronic device for the information.

17. The method of claim 14, further comprising
accessing electronic device information; and
integrating at least a portion of the electronic device information into the characterization, said portion pertaining to an electronic device that corresponds to said characterization.

18. The method of claim 17, further comprising
maintaining the electronic device information in a database.

19. The method of claim 14, further comprising
accessing service information; and
integrating at least a portion of the service information into the characterization, said portion pertaining to a service to which an electronic device corresponding to said characterization provides access.

20. The method of claim 19, further comprising
maintaining the service information in a database.

21. The method of claim 1, further comprising
modifying an electronic device corresponding to a characterization from the plurality of characterizations such that a state of the electronic device subsequently matches said characterization.

22. The method of claim 21, further comprising
scheduling said modifying each time the characterization is modified.

23. The method of claim 1, further comprising
modifying a characterization from the plurality of characterizations such that said characterization subsequently matches a state of an electronic device corresponding to said characterization.

24. The method of claim 23, further comprising
scheduling said modifying each time the state of the electronic device is modified.

25. The method of claim 1, further comprising
receiving a service profile, said service profile describing one or more service to which access is provided by an electronic device, said electronic device identified in said service profile; and
generating a characterization in response to said receiving, said characterization corresponding to said service profile.

25. The method of claim 1, further comprising
scanning a characterization from the plurality of characterizations to determine whether a corresponding electronic device includes a means for providing an access to a service; and
identifying an alternate means for providing the access if the means is not included in the corresponding electronic device.

26. The method of claim 25, wherein
the means comprises a software module.
